(19) United States
(12) Patent Application Publication
(10) Pub. No.: US 2003/0221126 A1
(43) Pub. Date: Nov. 27, 2003

(54) Mutual authentication with secure transport and client authentication

(75) Inventors: Eve Suzanne Berman, Binghamton, NY (US); David Yu Chang, Austin, TX (US); Derek Wan Hok Ho, Austin, TX (US); Stephen Patrick Lyons, Endicott, NY (US)

Correspondence Address: BIGGERS & OHANIAN, PLLC, 5 SCARLET RIDGE, AUSTIN, TX, 78737, US

(73) Assignee: INTERNATIONAL BUSINESS MACHINES CORPORATION, ARMONK, NY (US)

(21) Appl. No.: 10/156,809

(22) Filed: May 24, 2002

(51) Int. Cl. H04L 9/00

(52) U.S. Cl. 713/201; 713/150

(57) ABSTRACT

Methods for mutual authentication between a client and a server, including providing to the client an object reference comprising a component identifying the server's client authentication protocol, establishing an SSL connection between the client and the server, including authenticating the server with the server's public key, and authenticating the client using the client authentication protocol identified in the component in the object reference.

### BACKGROUND OF THE INVENTION

1. Field of the Invention

The field of the invention is data processing, or, more specifically, methods, systems, and products for mutual authentication.

2. Description of Related Art

“Authentication” means verification of a principal's network identity. A “principal” is an entity that is capable of believing that it can communicate securely with another entity. In “mutual authentication,” two principals, typically a client and a server, each authenticates the other. Embodiments of the present invention are concerned with mutual identification, and we begin our discussion, with reference to FIG. 2, by explaining a prior art Common Object Request Broker Architecture (“CORBA”) architecture upon which many embodiments of the present invention are implemented.

FIG. 2 shows a client (202) coupled for application purposes through an IDL stub (210) to an Object Request Broker (“ORB”) (214). The ORB is shown as a conceptual ORB backbone, because clients view CORBA calls from clients as being calls to an ORB even though the ORB software as such resides to a large extent on servers. Each client knows how to contact at least one local ORB, and ORBs generally can be viewed as comprising a backbone coupled through, for example, IIOP or the Internet Inter-ORB Protocol. FIG. 2 also shows a server (206) coupled to the ORB (214) through an IDL skeleton (212). “IDL” refers to CORBA's Interface Definition Language. IDL stubs and skeletons map client requests, or invocations of member methods, to the IDL understood by the ORB.

The client is shown as comprising a client application called a browser (204). Although many client applications in fact comprise browsers, many different kinds of client applications invoke CORBA objects. Therefore, in this disclosure, for generality and clarity we speak generally of “clients” as including client applications, rather than confusingly distinguishing the two. Server-side applications are known in the art as “servants” (208), but for similar reasons of generality and clarity, in this disclosure, unless a particular context requires otherwise, we usually refer to all server-side functionality and structure simply as a “server.”

FIG. 2 also depicts a standard protocol stack for secure networked data communications in the CORBA architecture. The stack includes a transport and network layer, tcp/ip (220); a security transport layer, the Secure Sockets Layer or “SSL” (218); and an inter-ORB protocol communications layer labeled “GIOP/IIOP” (216). Strictly speaking, “tcp,” the “Transmission Control Protocol,” is a separate layer residing above “ip,” the “Internet Protocol.” The two are so often spoken of together, however, that we label them together in FIG. 2. As discussed in more detail below, “GIOP” is the General Inter-ORB Protocol, and “IIOP” is the Internet Inter-ORB Protocol. That is, IIOP is an internet-oriented implementation of GIOP, which is why we label these two together in FIG. 2. Mutual authentication refers to a series of communications of data within this exemplary architecture, or a similar architecture, not necessarily exactly this architecture, intended to verify the identities of the client and the server.

If mutual authentication is done alone through use of digital certificates (secure containers for public keys) for and from both the client and the server, then system administrators are required to add the client's digital certificate to a server's key file and a server's digital certificate to all pertinent clients' key files. This approach takes a lot of overhead for administrators to manage digital certificates. If mutual authentication is accomplished alone through third party authentication services, such as, for example, Kerberos KDC services, multiple authentication messages are required among the client, the server, and the third party authentication service. In addition, message protection is usefully established before sending confidential data between the client and the server, an element that is not necessarily provided by third party authentication protocols.

For these reasons, it would be advantageous to have a way of establishing message protection early in a mutual authentication process, establish server authentication by use of a certificate issued by the server (requiring only one certificate maintained in the server's key file), and then use third party authentication for client authentication (requiring no client certificate storage in the server).

### SUMMARY OF THE INVENTION

Exemplary embodiments of the invention include methods for mutual authentication between a client and a server. Exemplary embodiments include providing to the client an object reference comprising a component identifying the server's client authentication protocol, establishing an SSL connection between the client and the server, including authenticating the server with the server's public key, and authenticating the client using the client authentication protocol identified in the component in the object reference. In some embodiments, the object reference includes an IOR. In some embodiments, the component identifying the server's client authentication protocol is a compound tagged component.

In exemplary embodiments of the invention, authenticating the client includes receiving from the client in an IIOP message a security context including the client's security information. In such embodiments, the server's client authentication protocol can be SSL. In some embodiments, the component identifying the server's client authentication protocol includes the following data elements: a tag, a numeric field indicating the length of the component, a Boolean indication whether CDR encoding is used, a major version, and a minor version. Some embodiments also include an identification of the server's client authentication protocol, target support associations options, target required association options, an SSL port number, a realm name, and a server name.

In some exemplary embodiments of the invention, the server's client authentication protocol is Basic Authentication, the component includes a server name and an optional DCE cell name, and authenticating the client includes receiving from the client through an SSL connection a DCE principal name and password. In some embodiments, the server's client authentication protocol is Basic Authentication, the component includes an MVS system identification and an MVS server name, and authenticating the client includes receiving from the client through an SSL connection an MVS user identification and a password.

In some exemplary embodiments, the server's client authentication protocol is Kerberos, the server is included in a Kerberos realm, the component includes an identification of the Kerberos realm of the server and a Kerberos principal name of the server, and authenticating the client includes receiving from the client through the SSL connection a Kerberos ticket. In some embodiments, the server's client authentication protocol is Basic Authentication, the component includes an optional server name and an optional domain name, and authenticating the client includes receiving from the client through the SSL connection a user identification and a password.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DFSCRIPTION OF THF DRAWINGS

FIG. 1 is a data flow diagram illustrating an exemplary embodiment of the present invention.

FIG. 2 is a prior art block diagram illustrating typical CORBA architecture with a protocol stack that includes SSL and GIOP/IIOP.

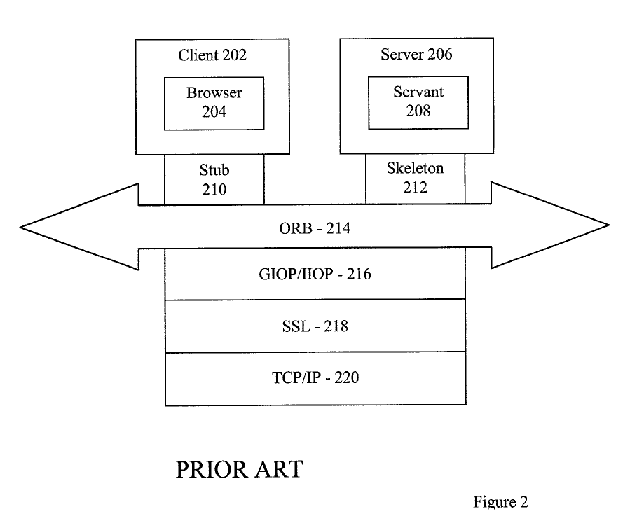

FIG. 3 illustrates a data structure for an exemplary embodiment of a compound tagged component of the present invention.

FIG. 4 is a data flow diagram illustrating an example of client authentication using Basic Authentication for a server in a Distributed Computing Environment (“DCE”)

FIG. 5 is a data flow diagram illustrating an example of client authentication using Basic Authentication for an MVS system.

FIG. 6 is a data flow diagram illustrating an example of client authentication using Kerberos.

FIG. 7 is a data flow diagram illustrating an example of client authentication using Basic Authentication with user ID and password.

### DETAILED DESCRIPTION OF EXEMPLARY EMBODIMENTS

### Introduction

The present invention is described to a large extent in this specification in terms of methods for mutual authentication. Persons skilled in the art, however, will recognize that any computer system that includes suitable programming means for operating in accordance with the disclosed methods also falls well within the scope of the present invention.

Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The invention also may be embodied in a computer program product, such as a diskette or other recording medium, for use with any suitable data processing system.

Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Definitions

“Authentication” means verification of a principal's network identity. A “principal” is an entity that is capable of believing that it can communicate securely with another entity. In DCE, for example, principals are represented as entries in a security database and include users, servers, computers and cells. “Mutual authentication” means that two principals, typically a client and a server, each authenticates the other.

“Basic Authentication” refers to one of the standard authentication protocols supported by IIS. Basic Authentication pops up a GUI window on a browser and prompts a user for a user name and password. Then Basic Authentication brings the user name and password back across a network from the browser to the IIS server with little or no encryption. Basic Authentication alone, without improvements of the kind provided by various embodiments of the present invention, therefore, is not very secure.

“CDR” means “Common Data Representation,” a hardware-independent parameter encoding scheme used in CORBA. CDR is a ‘raw’ binary encoding scheme. Other encoding schemes are possible under CORBA, including, for example, encoding in XML, the eXtensible Markup Language.

“CORBA” means the Common Object Request Broker Architecture, a standard for remote procedure invocation first published by the Object Management Group (“OMG”) in 1991. CORBA can be considered a kind of object-oriented way of making “RPCs” or remote procedure calls, although CORBA supports many features that do not exist in RPC as such. CORBA uses a declarative language, the Interface Definition Language (“IDL”), to describe an object's interface. Interface descriptions in IDL are compiled to generate ‘stubs’ for the client side and ‘skeletons’ on the server side. Using this generated code, remote method invocations effected in object-oriented programming languages such as C++ look like invocations of local member methods in local objects. Whenever a client program, such as, for example, a C++ program, acquires an object reference, decoded from a stringified object reference, from a Naming Service, or as result from another method invocation, an ORB creates a stub object. Since a stub object cannot exist without an object reference, and an object reference rarely exists outside a stub object, these two terms are often used synonymously. For the server side, a skeleton is generated by the IDL compiler. A developer derives from that skeleton and adds the methods' implementation; an object instance of such an implementation class is called a ‘servant.’ The generated skeleton receives requests from the ORB, unmarshalls communicated parameters and other data, and performs upcalls into the developer-provided code. This way, the object implementation also looks like a ‘normal’ class.

“DCE” refers to the Distributed Computing Environment, a middleware system from The Open Group. DCE services include remote procedure call (“RPC”), security services including authentication, directory service, time service, threads service, and distributed file service. DCE meets the CORBA specification as an “Environmental Specific Inter Orb Protocol.”

“GIOP” means General Inter-ORB Protocol, the CORBA protocol that defines structures and formats for passing messages among heterogeneous computers and their various architectures. GIOP is not based on any particular network protocol, like IPX or TCP/IP. In order to support interoperability, the OMG defines GIOP on top of a specific transport that will be supported by all vendors. Interoperability is not provided when there is a detailed and compact message specification that is nevertheless implemented by vendors over different transport mechanisms. The OMG therefore took the additional step of standardizing GIOP over the most widely used communication transport platform: tcp/ip. GIOP defined to function over tcp/ip is called “HOP,” the Internet Inter-ORB Protocol. Because of the general usefulness of tcp/ip, this disclosure, in describing example embodiments, tends to use the terms GIOP and HOP used more or less interchangeably, although the use of the term IIOP is not intended to limit application of embodiments of the present invention to the single transport protocol suite tcp/ip.

“IDL” refers to CORBA's Interface Definition Language, the CORBA standard for describing interfaces of CORBA objects.

“IIS” means Internet Information Server, Microsoft's web server that runs on Windows NT platforms.

“IOR” means Interoperable Object reference. In order to access a remote object, a CORBA client first needs the servant's address. This information is contained in ‘object references.’ While in older revisions the handling of object references was an implementation detail, they have been standardized in modem CORBA in an effort to provide interoperability among different Object Request Brokers (“ORBs”). IORs are opaque to developers: no information can be extracted from an IOR, and neither can an IOR be composed from known components.

IORs contain an optional IDL-declared type code and one or more profiles identifying modes of data transport. An IOR with more than one profile can make sense for redundancy purposes (two profiles can point to mirrored objects on different hosts), for quality of service purposes (one preferred profile for encrypted transport) or for optimization (one profile for local interprocess transport if the server is on the same host as the client, and another profile for remote transport). Profiles have various structures depending on the transport method represented by a particular profile. Internet transport is common today, however, so consider the example of IIOP profiles. IIOP profiles typically include (1) a fixed IIOP revision number, (2) the servant server's Internet host name (or dotted decimal IP address), (3) a TCP port number that the server is listening on, (4) a server-specific object key, and (5) optional “tagged components.”

“MVS” means Multiple Virtual Storage, the name of an IBM operating system introduced in 1974 and still operating on older IBM mainframes. MVS is largely superseded by IBM's newer operating system, OS/390.

“NFTS” means NT File System, one of the file systems supported by Microsoft's Windows NT operating system. NTFS has features to improve reliability, such as transaction logs to help recover from disk failures. To control access to files, permissions can be set for directories and/or individual files. NFTS supports Basic Authentication.

An “ORB” is a CORBA Object Request Broker.

“SSL” means Secure Sockets Layer, a protocol developed by Netscape for transmitting private documents via the Internet. SSL works by using a public key to encrypt data that's transferred over an SSL connection. Modern browsers support SSL, and many Web sites use SSL to obtain confidential user information, such as credit card numbers. By convention, URLs that require an SSL connection start with ‘HTTPS’ instead of ‘HTTP.’

A “tag,” as the term in used in this disclosure, is a value that distinguishes one type of thing from another. The CORBA specifications describe many data structures and interfaces that ORBs and object services built by different vendors must share in order to work together. Some of those interfaces and data structures allow for the possibility of proprietary extensions or additions; others are designed to allow for future standardized extensions. In these cases, any number of possible variations or combinations of element types might occur in data being shared between ORBs. In order to be able to distinguish between them, the CORBA specifications usually express them as tagged elements, meaning that the element in question is preceded by a unique numeric value that distinguishes it from other element types.

To make sure that two vendors do not unintentionally use the same tag value for different things, the OMG acts as an allocation authority, keeping track of values that have already been allocated by different vendors, and allocating new unique tag values on request. Tag values generally are 32-bit unsigned integers.

Supported tag types include tags for IOR Profile IDs, Service Context IDs, ORB Type IDs, Component IDs, and Vendor Minor Code IDs (“VMCIDs”). Detailed descriptions for all supported CORBA tags are set forth in the current CORBA specifications. In this disclosure, we are particularly interested in tagged Service Contexts and tagged Components.

A “profile” is a data structure in an IOR that describes a mechanism or set of mechanisms (typically a protocol stack) that can be used to send requests to the object represented by the IOR. The standard IIOP profile, for example, contains a host address, port number, and object key that any CORBA 2.0-compliant ORB can use to make a connection to the appropriate server and send a request to the object. Vendors can also make objects available through proprietary protocols. In addition to the IIOP profile, an IOR may contain other profiles that describe how different protocols may be used to access the same object. When a client written with a particular ORB receives an IOR, it must be able to examine the IOR contents, determine which of the profiles it knows how to use, and choose from among those the one with which it will attempt to invoke the object. Often a client written with a particular vendor's ORB will prefer to use a native proprietary protocol because it offers performance enhancements or enables extra features. In order to do this, clients must be able to reliably distinguish one of their native profiles from the standard IIOP profile or other vendors' native profiles. Vendors and other ORB implementers can allocate unique tag values to identify their profiles.

“Service Contexts” are data structures communicated in GIOP messages. GIOP messages allow for implicit service-related information to be passed in requests and replies. When a client sends a request to a remote object, there may be information in the client execution context (such as an open transaction context) that will affect how the request will be executed on the server. The client ORB is responsible for obtaining this information from the object service that manages it, and sending it as part of the request message. Replies may similarly return information that may be added to the client's context before returning from the operation invocation. Service context elements are identified by tag values. Vendors are free to convey proprietary information in the service context element of GIOP messages. In order to do so, unique identifying tag values should be allocated to distinguish the vendor's particular use of service context from other uses.

“Profile Components,” referred to often in this disclosure as “tagged components,” are optional data structures in IOR profiles. Vendors are allowed to devise their own components for internal use by their ORB, or by other ORBs modified to recognize and administer a vendor's tagged components. Tagged components allow vendors and developers to pass additional information within object references. Vendors must allocate unique component type ID tag value to reliably distinguish their components from those of other ORB vendors.

### Detailed Description

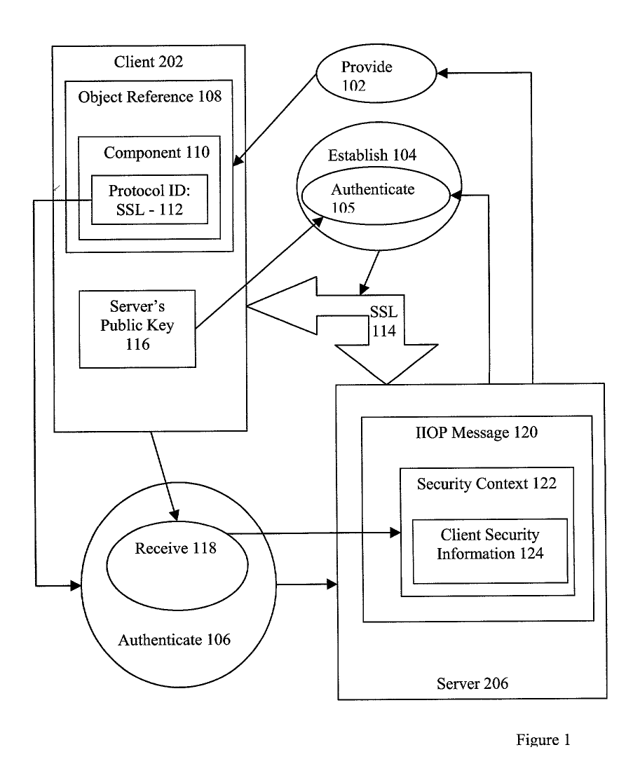

Turning now to FIG. 1, a first example embodiment of the invention is seen illustrated as a method for mutual authentication between a client (202) and a server (206). Embodiments according to FIG. 1 typically include providing (102) to the client (202) an object reference (108) comprising a component (110) identifying the server's client authentication protocol (112). Such embodiments typically include establishing (104) an SSL connection (114) between the client (202) and the server (206), including authenticating (105) the server (206) with the server's public key (116). The example embodiment of FIG. 1 includes authenticating (106) the client (202) using the client authentication protocol (112) identified in the component (110) in the object reference (108). In the particular example of FIG. 1, the client authentication protocol (112) identified in the component (110) is SSL. In some embodiments of the present invention, the object reference (108) comprises an IOR. In other embodiments, the component (110) identifying the server's client authentication protocol (112) comprises a compound tagged component. In at least some exemplary embodiments, authenticating the client includes receiving from the client in an IIOP message a security context including the client's security information, such as, for example, user names, passwords, security tokens or tickets, and so on.

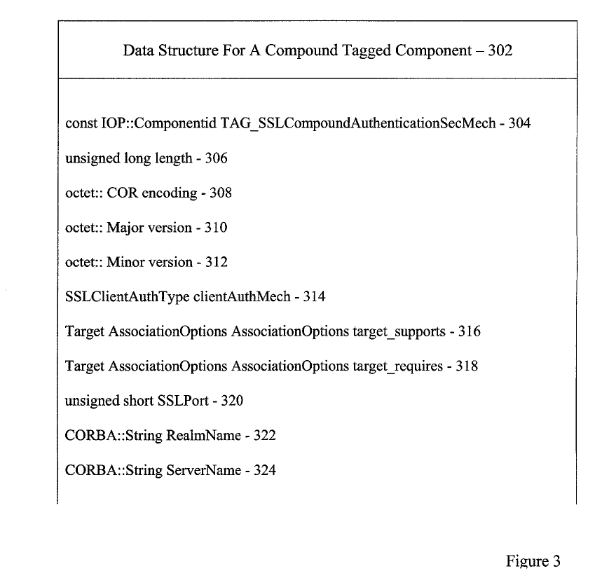

FIG. 3 illustrates an example of a data structure useful in various embodiments of the present invention as an implementation of a compound tagged component. In exemplary embodiments according to the example of FIG. 3, the component identifying the server's client authentication protocol includes the following data elements: a tag (304), a numeric field indicating the length of the component (306), a Boolean indication whether CDR encoding is used (308), a major version (310), and a minor version (312). Such embodiments also include an identification of the server's client authentication protocol (314), target supported associations options (316), target required association options (318), an SSL port number (320), a realm name (322), and a server name (324).

The example data structure of FIG. 3 is set forth in the Common Data Representation (“CDR”) transfer syntax, the format in which GIOP represents OMG IDL data types in octet streams. Of course any syntax, JAVA, C, C++, or others as would occur to those of skill in the art, could be used to describe the data structure in question, but we speak so often in terms of CORBA in this disclosure that CDR seems appropriate.

In the example of FIG. 3, the tag (304) is an IDL const IOP::Componentid named “TAG_SSLCompoundAuthenticationSecMech” having a tag value of 49424dO8. The unsigned long named “length” 306) is a numeric field indicating the length of the component, in this case indicating the compound tagged component (302) itself. The octet named “CDRencoding” (308) is a Boolean indication that CDR encoding is used.

The octet named “Major version” (310), having in this example the value 1, indicates the major revision number of the compound tagged component (302). A major version change indicates either an incompatible version change, either syntactic or semantic. For embodiments of the present invention, a down leveled server will treat a known higher major version as an unknown context. A minor version (312), in this case the octet named “Minor version” and having the example value 0, indicates a compatible version change received at a supported revision level.

The SSLClientAuthType named “clientAuthMech” is an enum that identifies the server's client authentication protocol (314) or mechanism. An example of one way to embody “clientAuthMech” is to define enumerated values representing various client authentication protocols or mechanisms, including, for example:

const DigitialCerts=0 to indicate client authentication by SSL alone,

const DCE=1 to indicate Basic Authentication in a DCE environment,

const MVS=2 to indicate Basic Authentication in an MVS environment,

const KRB5Token=3 to indicate client authentication with Kerberos, and

const UidPw=4 to indicate Basic Authentication over SSL.

In the example of FIG. 3, the AssociationOptions elements named “target_supports” (316) and “target_requires” (318) respectively indicate allowed and required message protection in applicable CORBA security policies. The meanings of typical supported values for AssociationsOptions elements are set forth in the following table:

CORBA/IIOP/SSL AssociationsOptions Semantics

| | Meanings | |
|---|---|---|
| Typical Values | target_supports | target_requires |
| NoProtection | Target supports | Target's minimum protection |
| | unprotected | requirement is unprotected |
| | messages. | messages. |
| Integrity | Target supports | Target requires messages to |
| | integrity- | be integrity-protected. |
| | protected | |
| | messages. | |
| Confidentiality | Target supports | Target requires messages to |
| | confidentiality- | be confidentiality-protected. |
| | protected | |
| | messages | |
| DetectReplay | Target can detect | Target requires detection of |
| | replay of | message replay. |
| | requests. | |
| DetectMisordering | Target can detect | Target requires detection of |
| | sequence errors | message missequencing. |
| | of requests. | |
| EstablishTrustInTarget | Target is prepared | (Not a valid option.) |
| | to authenticate | |
| | identity to | |
| | the client. | |
| EstablishTrustInClient | Target is capable | Target requires establishment |
| | of authenticating | of trust in the client's |
| | the client. | identity. |

An SSL port number (320) is identified by the unsigned short named “SSLPort” in FIG. 3. Just as the HyperText Transfer Protocol (“HTTP”) addresses port 80 by default, the SSL “HTTPS” specification addresses port 443 when the port number is omitted from SSL messages or SSL-related URLs or URIs. Any port number can be designated as an SSL port, either by association with a certificate, or, as shown in FIG. 3, by designation in a tagged component in an object reference or an IOR.

The CORBA::String called “realmname” in the data structure of FIG. 3 is used to communicate a realm name when needed, as, for example, in client authentication with Kerberos. Similarly, the CORBA::String “ServerName” is used as needed to communicate a server name, as, for example, in client authentication with Basic Authentication.

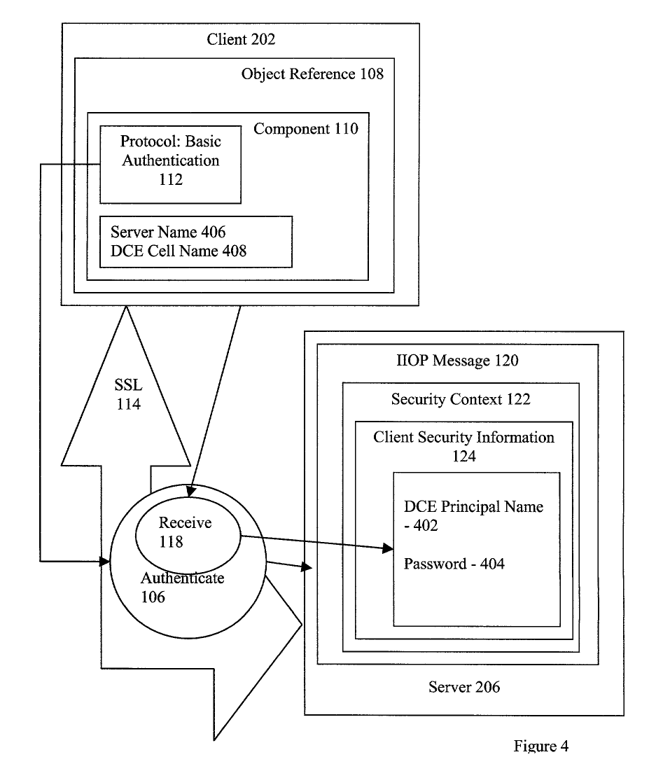

FIG. 4 illustrates a further example embodiment of the invention in which the server's client authentication protocol (112) is Basic Authentication in a Distributed Computing Environment (“DCE”). In such embodiments, the component (110) includes a server name (406) and an optional DCE cell name (408). In embodiments according to the example of FIG. 4, authenticating (106) the client includes receiving (118) from the client through the SSL connection (114) a DCE principal name (402) and password (404). Basic Authentication in DCE also means generally that the client's DCE user ID and password are sent over SSL to the server. The server recognizes the DCE user ID and password and then authenticates the client with a DCE security server. In embodiments of this kind, there is no requirement for the server itself to maintain clients' public keys.

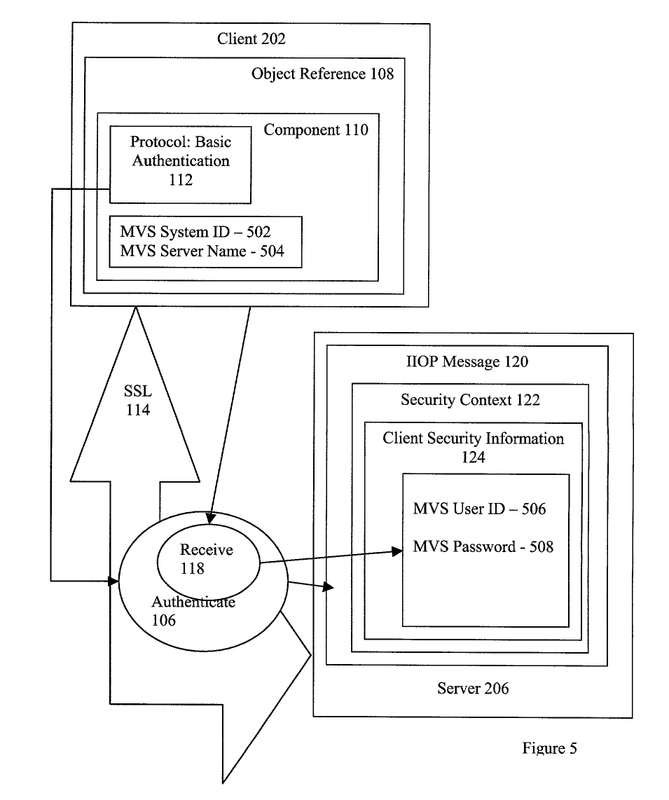

FIG. 5 illustrates a still further example embodiment of the invention in which the server's client authentication protocol (112) is Basic Authentication used in an MVS environment. In embodiments of the kind shown in FIG. 5, the component (110) typically includes an MVS system identification (502) and an MVS server name (504). In such embodiments, authenticating (106) the client typically includes receiving (118) from the client (202) through the SSL connection (114) an MVS user identification (124) and a password (508). Basic Authentication for MVS also means generally that the MVS user ID and password are passed over SSL from the client to the server. The server then authenticates the client with the MVS operating system's security service using the client's user ID and password.

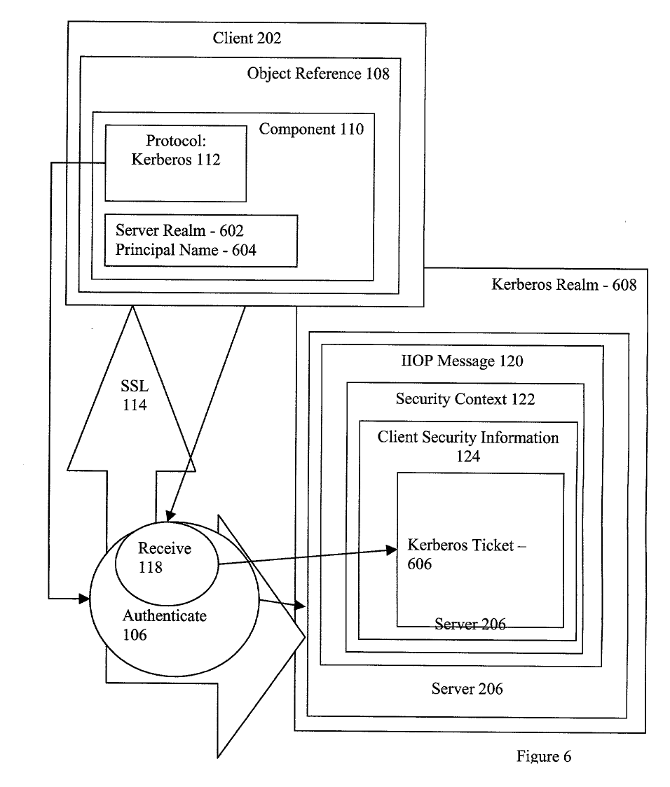

FIG. 6 illustrates an even further example embodiment in which the server's client authentication protocol (112) is Kerberos. In such embodiments, the server (206) is included in a Kerberos realm (608), and the component (110) includes an identification of the Kerberos realm of the server (602) and a Kerberos principal name of the server (604). In embodiments of this kind, authenticating (106) the client includes receiving (118) from the client (202) through the SSL connection (114) a Kerberos ticket (606). That is, client authentication in such embodiments includes receiving a Kerberos ticket (606) from the client (202) as an authenticated Kerberos principal.

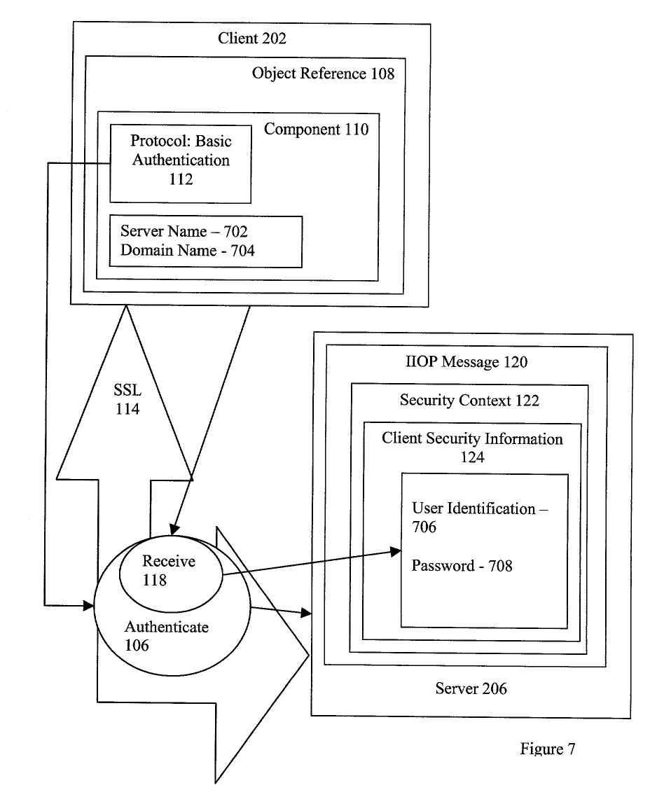

FIG. 7 illustrates a still further example embodiment in which the server's client authentication protocol (112) is Basic Authentication over SSL. In such embodiments, the component (110) typically includes an optional server name (702) and an optional domain name (704). In such embodiments, authenticating the client (106) includes receiving (118) from the client (202) through the SSL connection (114) a user identification (706) and a password (708). More particularly, client authentication with SSL means that the client is authenticated with the server by use of the server's public key in a PKI security architecture. The client's authentication information such as user ID and password are sent from the client to the server with the SSL protocol which provides message protection for the client's authentication information. The server then authenticates the client's authentication information with a third party authentication server such as a DCE security server or a Kerberos server.

“PKI” means ‘Public Key Infrastructure, a combination of software, encryption technologies, and services that enables enterprises to protect the security of their communications and business transactions on the Internet. PKIs integrate digital certificates, public-key cryptography, and certificate authorities into an enterprise-wide network security architecture. A typical PKI includes the issuance of digital certificates to individual users and servers; end-user enrollment software; integration with corporate certificate directories; tools for managing, renewing, and revoking certificates; and related services and support. In conventional PKIs, the administrative burden of carrying all of the client's public keys is huge. An important advantage of client authentication with SSL in accordance with embodiments of the present invention is that enterprise security servers are not required to carry clients' public keys.

Readers by now understand the benefits of using various embodiments of the present invention for mutual authentication in network environments. In typical embodiments, a secure transport mechanism in the form of SSL is used to authenticate the server, so that except for extremely preliminary communications (such as transfer of a certificate, for example), all communications requiring message protection are encrypted. In typical embodiments, a third party client authentication service is used to authenticate the client, thus leaving client certificate administration, for the most part, in the hands of the trusted third party and offloading client certificate administration from system administrators. System administrators only need to manage the server's digital certificate, a much more manageable burden. The client's security information is registered with the third party authentication service. Our exemplary embodiments have been discussed largely in connection with OMG security services as a third party authentication service, although there is no limitation in that regard; use of any third party authentication service as will occur to those of skill in the art is well within the scope of the present invention.

It is expected that the use of SSL as security transport in conjunction with OMG security service will be a common class of embodiments. OMG security services define an SSL tagged component with SSL port 10 and a host IP address. SSL can be used to carry OMG GlOP messages containing security service contexts. Security service contexts can be used to transfer the client's security information such as user IDs, passwords, and security tokens (or tickets) to the server to establish security associations above the level of the SSL protocol.

In embodiments that use SSL, by placing the server's public key (digital certificate) in the client's key file and the server's private key in the server's key file, SSL can be configured to perform the server authentication when the SSL socket is created or opened. The client can be authenticated with the server by a third party authentication service, including, for example, an OMG CSlv2 service or a service implementing the IBM security protocol.

For embodiments using an OMG security service, a special OMG tagged component is defined for mutual authentication in various embodiments of the present invention with SSL secure transport and client authentication through a third party authentication service. A compound OMG tagged component is defined for the SSL security transport to establish different security information to establish security associations above SSL. The benefit of the SSL compound tagged component is that a single OMG tagged component can be shared by multiple security mechanisms with the SSL as the security transport. In such embodiments, when a client is provided with a particular compound OMG tagged component (typically as part of an IOR), the client is programmed to examine the contents of the compound tagged component, determine which client authentication mechanism is identified as supported or required by the server, and carry out its part of client authentication in accordance with the identified mechanism.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for mutual authentication between a client and a server, the method comprising:
providing to the client an object reference comprising a component identifying the server's client authentication protocol;
establishing an SSL connection between the client and the server, including authenticating the server with the server's public key; and
authenticating the client using the client authentication protocol identified in the component in the object reference.

2. The method of claim 1 wherein the object reference comprises an IOR.

3. The method of claim 2 wherein the component identifying the server's client authentication protocol is a compound tagged component.

4. The method of claim 1 wherein authenticating the client further comprises receiving from the client in an IIOP message a security context including the client's security information.

5. The method of claim 1 wherein the server's client authentication protocol is SSL.

6. The method of claim 1 wherein the component identifying the server's client authentication protocol comprises the following data elements:
a tag,
a numeric field indicating the length of the component,
a Boolean indication whether CDR encoding is used,
a major version,
a minor version,
an identification of the server's client authentication protocol,
target support associations options,
target required association options,
an SSL port number,
a realm name, and
a server name.

7. The method of claim 1 wherein
the server's client authentication protocol is Basic Authentication,
the component includes a server name and an optional DCE cell name, and
authenticating the client further comprises receiving from the client through the SSL connection a DCE principal name and password.

8. The method of claim 1 wherein
the server's client authentication protocol is Basic Authentication,
the component includes an MVS system identification and an MVS server name, and
authenticating the client further comprises receiving from the client through the SSL connection an MVS user identification and a password.

9. The method of claim 1 wherein
the server's client authentication protocol is Kerberos,
the server is included in a Kerberos realm,
the component includes an identification of the Kerberos realm of the server and a Kerberos principal name of the server, and
authenticating the client further comprises receiving from the client through the SSL connection a Kerberos ticket.

10. The method of claim 1 wherein
the server's client authentication protocol is Basic Authentication,
the component includes an optional server name and an optional domain name, and
authenticating the client further comprises receiving from the client through the SSL connection a user identification and a password.

11. A system for mutual authentication between a client and a server, the system comprising:
means for providing to the client an object reference comprising a component identifying the server's client authentication protocol;
means for establishing an SSL connection between the client and the server, including authenticating the server with the server's public key; and
means for authenticating the client using the client authentication protocol identified in the component in the object reference.

12. The system of claim 11 wherein the object reference comprises an IOR.

13. The system of claim 12 wherein the component identifying the server's client authentication protocol is a compound tagged component.

14. The system of claim 11 wherein means for authenticating the client further comprises means for receiving from the client in an IIOP message a security context including the client's security information.

15. The system of claim 11 wherein the server's client authentication protocol is SSL.

16. The system of claim 11 wherein the component identifying the server's client authentication protocol comprises the following data elements:
a tag,
a numeric field indicating the length of the component,
a Boolean indication whether CDR encoding is used,
a major version,
a minor version,
an identification of the server's client authentication protocol,
target support associations options,
target required association options,
an SSL port number,
a realm name, and
a server name.

17. The system of claim 11 wherein
the server's client authentication protocol is Basic Authentication,
the component includes a server name and an optional DCE cell name, and
means for authenticating the client further comprises means for receiving from the client through the SSL connection a DCE principal name and password.

18. The system of claim 11 wherein
the server's client authentication protocol is Basic Authentication,
the component includes an MVS system identification and an MVS server name, and
means for authenticating the client further comprises means for receiving from the client through the SSL connection an MVS user identification and a password.

19. The system of claim 11 wherein
the server's client authentication protocol is Kerberos,
the server is included in a Kerberos realm,
the component includes an identification of the Kerberos realm of the server and a Kerberos principal name of the server, and
means for authenticating the client further comprises means for receiving from the client through the SSL connection a Kerberos ticket.

20. The system of claim 11 wherein
the server's client authentication protocol is Basic Authentication,
the component includes an optional server name and an optional domain name, and
means for authenticating the client further comprises means for receiving from the client through the SSL connection a user identification and a password.

21. A computer program product for mutual authentication between a client and a server, the computer program product comprising:
a recording medium;
means, recorded on the recording medium, for providing to the client an object reference comprising a component identifying the server's client authentication protocol;
means, recorded on the recording medium, for establishing an SSL connection between the client and the server, including authenticating the server with the server's public key; and
means, recorded on the recording medium, for authenticating the client using the client authentication protocol identified in the component in the object reference.

22. The computer program product of claim 21 wherein the object reference comprises an IOR.

23. The computer program product of claim 22 wherein the component identifying the server's client authentication protocol is a compound tagged component.

24. The computer program product of claim 21 wherein means, recorded on the recording medium, for authenticating the client further comprises means, recorded on the recording medium, for receiving from the client in an IIOP message a security context including the client's security information.

25. The computer program product of claim 21 wherein the server's client authentication protocol is SSL.

26. The computer program product of claim 21 wherein the component identifying the server's client authentication protocol comprises the following data elements:
a tag,
a numeric field indicating the length of the component,
a Boolean indication whether CDR encoding is used,
a major version,
a minor version,
an identification of the server's client authentication protocol,
target support associations options,
target required association options,
an SSL port number,
a realm name, and
a server name.

27. The computer program product of claim 21 wherein
the server's client authentication protocol is Basic Authentication,
the component includes a server name and an optional DCE cell name, and
means, recorded on the recording medium, for authenticating the client further comprises means, recorded on the recording medium, for receiving from the client through the SSL connection a DCE principal name and password.

28. The computer program product of claim 21 wherein
the server's client authentication protocol is Basic Authentication,
the component includes an MVS system identification and an MVS server name, and
means, recorded on the recording medium, for authenticating the client further comprises means, recorded on the recording medium, for receiving from the client through the SSL connection an MVS user identification and a password.

29. The computer program product of claim 21 wherein
the server's client authentication protocol is Kerberos,
the server is included in a Kerberos realm,
the component includes an identification of the Kerberos realm of the server and a Kerberos principal name of the server, and
means, recorded on the recording medium, for authenticating the client further comprises means, recorded on the recording medium, for receiving from the client through the SSL connection a Kerberos ticket.

30. The computer program product of claim 21 wherein
the server's client authentication protocol is Basic Authentication,
the component includes an optional server name and an optional domain name, and
means, recorded on the recording medium, for authenticating the client further comprises means, recorded on the recording medium, for receiving from the client through the SSL connection a user identification and a password.
